(19) United States
(12) Patent Application Publication
(10) Pub. No.: US 2020/0231001 A1
(43) Pub. Date: Jul. 23, 2020

(54) DEFLATION SAFETY SYSTEM AND SYSTEM INCLUDING SAME

(71) Applicant: Hutchinson Industries, Inc., Trenton, NJ (US)

(72) Inventors: Christopher R. RENSON, Langhorne, PA (US); Michael G. HARTMAN, Lansdale, PA (US); Lars Johan RESARE, Ewing, NJ (US); Larry W. STUCK, Amherst, NY (US); Olivier NOBLANC, Levittown, PA (US); Peter K. HOBE, Levittown, PA (US)

(21) Appl. No.: 16/750,084

(22) Filed: Jan. 23, 2020

Related U.S. Application Data
(60) Provisional application No. 62/795,834, filed on Jan. 23, 2019.

(51) Int. Cl. B60B 25/00; B60C 29/02; B60B 25/10; B60B 25/20

(52) U.S. Cl. CPC B60B 25/004; B60C 29/02; B60B 2900/511; B60B 25/20; B60B 25/10

(57) ABSTRACT

A system is disclosed. The system includes an adapter member and a safety member. The adapter member includes a fill valve, an internal passageway and a boss member positioned within a multi-piece wheel. The safety member is removably connected to the adapter member, and covers nuts which removably connect a first piece of the multi-piece wheel to a second piece of the multi-piece wheel.

### CROSS-REFERENCE TO RELATED APPLICATION

This application claims the benefit under 35 U.S.C. § 119(e) of the earlier filing date of U.S. Provisional Patent Application No. 62/795,834 filed on Jan. 23, 2019, titled DEFLATION SAFETY SYSTEM AND SYSTEM INCLUDING SAME, the contents of which are hereby incorporated by reference in their entirety.

### BACKGROUND

This application discloses an invention which is related, generally and in various aspects, to a deflation safety system and a system including the same.

FIG. 1 illustrates a prior art multi-piece wheel 10. The multi-piece wheel 10 includes a first piece 12 and a second piece 14 which are connected to one another by a plurality of bolts 16 and corresponding nuts 18 to form the multi-piece wheel 10. The first piece 12 of the multi-piece wheel 10 includes first flange portion 20, a first barrel portion 22 which is axially aligned with an axis of rotation (not shown for purposes of clarity) of the multi-piece wheel 10, and a first wall portion 24 which is transverse to the axis of rotation of the multi-piece wheel 10. The second piece 12 of the multi-piece wheel 10 includes second flange portion 26, a second barrel portion 28 which is axially aligned with the axis of rotation of the multi-piece wheel 10, and a second wall portion 30 which is transverse to the axis of rotation of the multi-piece wheel 10. Collectively, the first and second barrel portions 22, 28 form a barrel portion 32 of the multi-piece wheel 10. Collectively, the first and second wall portions 24, 30 form a transverse wall 34 which defines a central opening 36 of the multi-piece wheel 10. In some aspects, a sealing member 37 is positioned between the first and second wall portions 24, 30.

As shown in FIG. 1, a tubeless tire 38 can be mounted to the multi-piece wheel 10. The tubeless tire 38 includes a tread portion 40, a first sidewall portion 42 and a second sidewall portion 44. When mounted to the multi-piece wheel 10, the tubeless tire 38 and the barrel portion 32 cooperate to define a cavity 46. When the cavity 46 is filled with a pressurized fluid (e.g., air), the pressurized fluid operates to inflate the tubeless tire 38. As the cavity 46 is inflated, a beaded/thickened portion 48 of the first sidewall portion 42 is pressed against the first flange portion 20 and a beaded/thickened portion 50 of the second sidewall portion 44 is pressed against the second flange portion 26.

According to various aspects, the multi-piece wheel 10 also includes an internal passageway 52 which extends from an “outboard” side of the multi-piece wheel 10 to the cavity 46 formed by the tubeless tire 38 and the barrel portion 32 of the multi-piece wheel 10, and an inflation valve 54 which is connected to the internal passageway 52. Internal passageways such as internal passageway 52 are described in more detail, for example, in U.S. Pat. Nos. 6,474,383, 8,006,731 and 8,069,890, the entire content of each which are hereby incorporated by reference.

A concern with a multi-piece wheel such as the multi-piece wheel 10 described above is that if a person disassembling the multi-piece wheel 10 removes too many of the nuts 18 from the bolts 16 without first deflating the tubeless tire 38, the pressure within the cavity 46 can be sufficient to cause the first piece 12 of the multi-piece wheel 10 to separate from the second piece 14 of the multi-piece wheel 10, even if a number of the nuts 18 and bolts 16 are still in place. In certain instances, depending on the pressure within the cavity 46 and the number of nuts 18 and bolts 16 still in place, the separation of the first piece 12 of the multi-piece wheel 10 from the second piece 14 of the multi-piece wheel 10 can be very forceful and rather violent, potentially causing serious injury and even death to the person disassembling the multi-piece wheel 10.

FIG. 2 illustrates a prior art system 60 which addresses this concern. The system 60 includes a safety ring 62 and a plurality of fasteners 64 (although only one is shown in FIG. 2). The fasteners 64 are utilized to removably connect the safety ring 62 to the transverse wall 34 of a multi-piece wheel 10. When removably connected to the multi-piece wheel 10, the safety ring 62 covers the nuts 18 and the corresponding bolts 16 which connect the first piece 12 of the multi-piece wheel 10 to the second piece 14 of the multi-piece wheel 10, and also presses against an O-ring 66 to seal off the outboard end of the internal passageway 52, thereby preventing the pressurized fluid within the cavity 46 from escaping to the atmosphere.

In order for a person to disassemble the multi-piece wheel 10 shown in FIG. 2, the person needs to access the nuts 18 which are covered by the safety ring 62. However, in order to access the nuts 18, the person first needs to remove the fasteners 64, then pull the safety ring 62 away from the multi-piece wheel 10. When the safety ring 62 is pulled away from the multi-piece wheel 10 in an axial direction, the outboard end of the internal passageway 52 is unsealed and the pressurized fluid in the cavity 46 can then escape to the atmosphere, thereby lowering the pressure within the cavity 46. Due to the lower pressure within the cavity 46, the risk of the first piece 12 of the multi-piece wheel 10 being violently separated from the second piece 14 of the multi-piece wheel 10 before all of the nuts 18 are removed from the corresponding bolts 16 is mitigated. Safety rings such as safety ring 62 are described in more detail in U.S. Pat. No. 8,505,598, the entire content of which is hereby incorporated by reference.

There are a significant number of existing multi-piece wheels, and many of such multi-piece wheels are configured differently. For example, many of such multi-piece wheels have different diameters, have internal passages which are of different diameters, have internal passages which follow different paths within the multi-piece wheel and/or terminate at different locations on the multi-piece wheel. Although different deflation safety systems can be produced for each different multi-piece wheel, the overall cost incurred by and/or associated with such an approach renders it infeasible. Rather, it is desirable to be able to utilize a given safety ring (or similarly functional component) for a number of different multi-piece wheels, including both new and existing multi-piece wheels.

### BRIEF DESCRIPTION OF THE DRAWINGS

The novel features of the aspects described herein are set forth with particularity in the appended claims. The aspects, however, both as to organization and methods of operation may be better understood by reference to the following description, taken in conjunction with the accompanying drawings.

FIG. 1 illustrates a prior art multi-piece wheel.

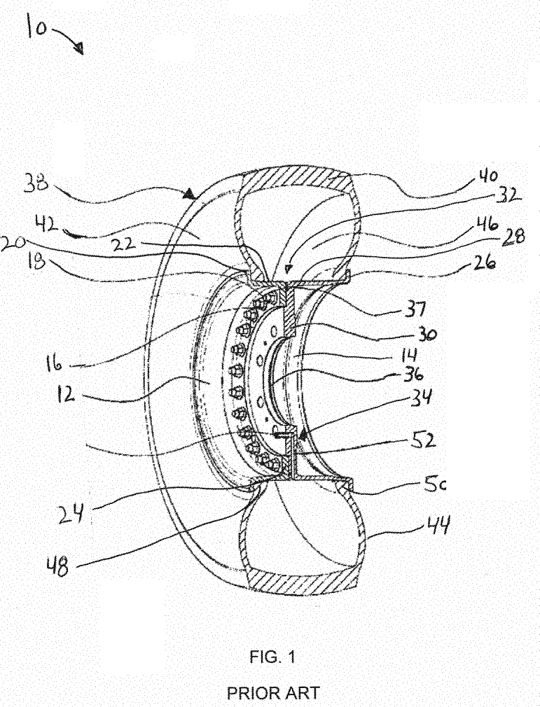

FIG. 2 illustrates a prior art system.

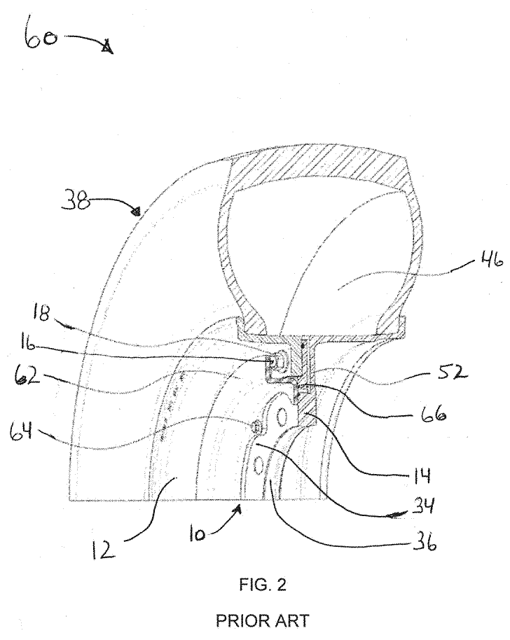

FIG. 3 illustrates a cross-section of a deflation safety system, in accordance with at least one aspect of the present disclosure;

FIG. 4 illustrates an exploded view of the cross-section of the system of FIG. 3, in accordance with at least one aspect of the present disclosure;

FIG. 5 illustrates an exploded perspective view of the system of FIG. 3, in accordance with at least one aspect of the present disclosure;

FIG. 6 illustrates a cross-section of another deflation safety system, in accordance with at least one aspect of the present disclosure;

FIG. 7 illustrates an exploded view of the cross-section of the system of FIG. 6, in accordance with at least one aspect of the present disclosure;

FIG. 8 illustrates a cross-section of yet another deflation safety system, in accordance with at least one aspect of the present disclosure; and

FIG. 9 illustrates an exploded view of the cross-section of the system of FIG. 8, in accordance with at least one aspect of the present disclosure.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various aspects of the systems in detail, it should be noted that the various aspects disclosed herein are not limited in their application or use to the details of construction and arrangement of parts illustrated in the accompanying drawings and description. Rather, the disclosed aspects may be positioned or incorporated in other aspects, embodiments, variations and modifications thereof, and may be practiced or carried out in various ways. Accordingly, aspects of the systems disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as inward, outward, upward, downward, above, below, left, right, interior, exterior, axially, radially and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

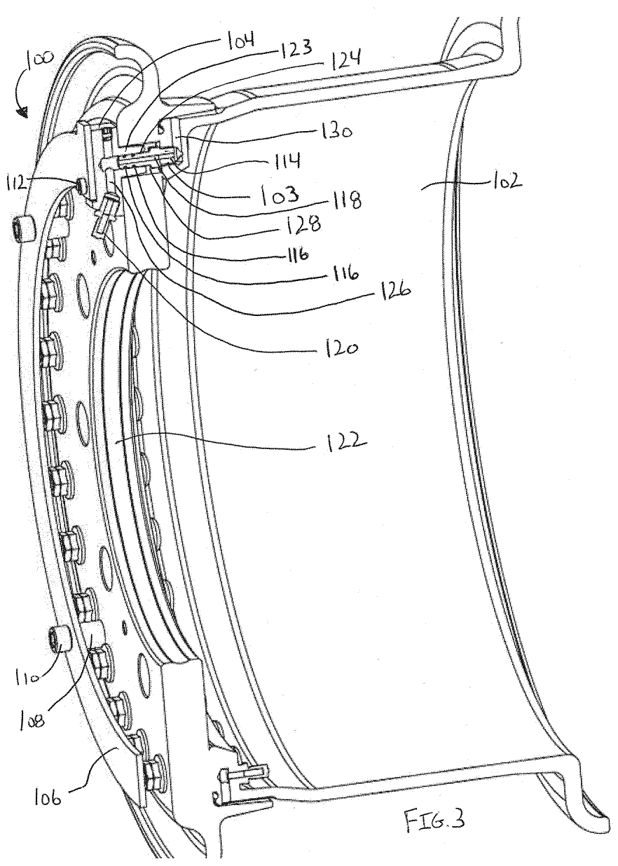

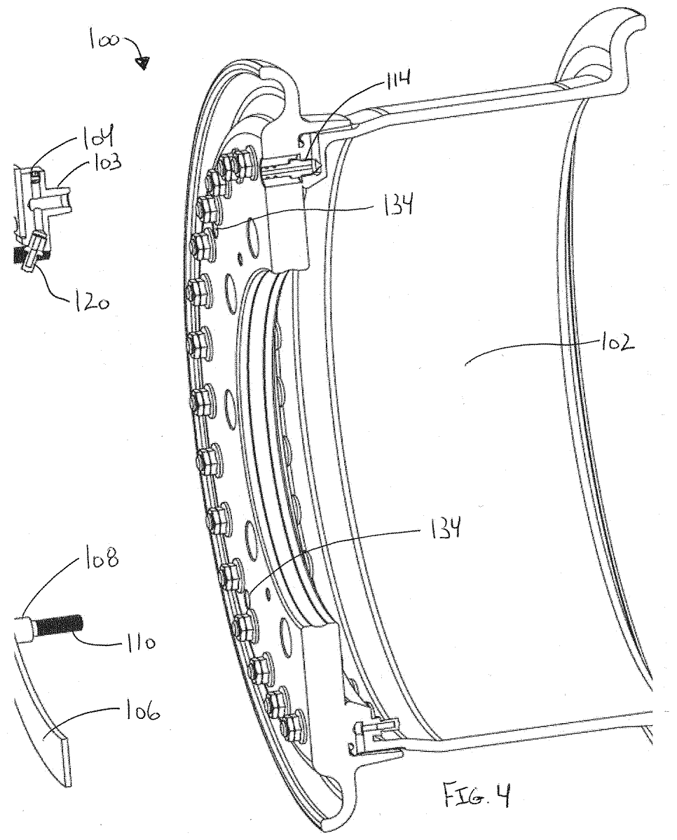

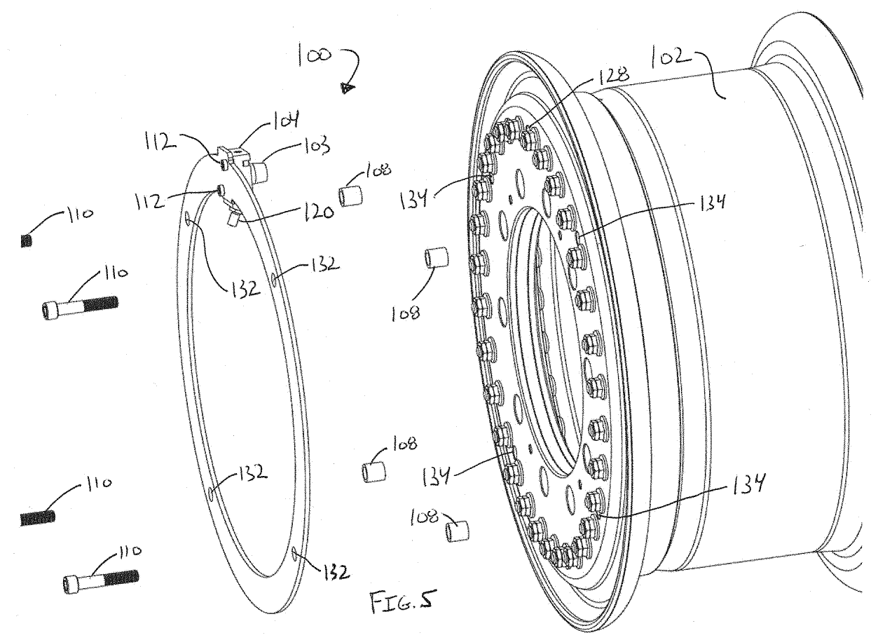

FIGS. 3-5 illustrate a deflation safety system 100, in accordance with at least one aspect of the present disclosure. The deflation safety system 100 can be utilized to safely disassemble a multi-piece wheel 102. FIG. 3 is a cross-section of the system 100, FIG. 4 is an exploded view of the cross-section of the system 100, and FIG. 5 is an exploded perspective view of the system 100. The multi-piece wheel 102 may be similar or identical to the multi-piece wheel 10 described above, and may have a tubeless tire mounted thereon as described above. For purposes of simplicity the tubeless tire is not shown in FIG. 3, and only a cross-section of the system 100 and the multi-piece wheel 102 is shown.

The system 100 includes an adapter member 104, a safety member 106, a plurality of standoff members 108, a plurality of corresponding fasteners 110, and fasteners 112. According to various aspects, the system 100 also includes a fitting member 114 and at least one radial sealing member 116. As shown in FIG. 3, the system 100 may include two radial sealing members 116. In accordance with various aspects, the system 100 forms part of a system which also includes the multi-piece wheel 102, including the nuts, bolts, internal passageways, etc. of the multi-piece wheel 102, and may also include a tire mounted on the multi-piece wheel 102.

To utilize the system 100 with an existing multi-piece wheel, a fill valve (not shown) is unscrewed from a threaded fill valve opening 103 of the multi-piece wheel 102 and removed from an opening 128 of the multi-piece wheel 102. The opening 128 is concentric with the threaded fill valve opening 103 and has a slightly larger diameter. Thereafter, the fitting member 114 is inserted into the opening 128 and screwed into the threaded fill valve opening 103 of the multi-piece wheel 102. According to various aspects, the fitting member 114 incorporates the radial sealing members 116. In accordance with various aspects, each of the radial sealing members 116 are O-rings. The fitting member 114 includes an internal passageway 118.

The adapter member 104 includes a fill valve 120, a boss member 123 which includes an opening 124 configured to receive and surround the fitting member 114, and an internal passageway 126. The adapter member 104 can be configured so that the fill valve 120 faces at an angle parallel to the face of the transverse wall of the multi-piece wheel 102 as shown in FIG. 3. In some aspects, the adapter member 104 is configured so that the fill valve 120 faces perpendicular to the axis of rotation of the multi-piece wheel 102 toward a central opening 122 of the multi-piece wheel 102. The central opening 122 may be similar or identical to the central opening 36 described above. In other aspects, the adapter member 104 is configured so that the fill valve 120 faces parallel to the axis of rotation of the multi-piece wheel 102 (e.g., perpendicular to the transverse face of the multi-piece wheel 102).

After the fitting member 114 is screwed into the threaded fill valve opening 103 of the multi-piece wheel 102, the boss member 123 of the adapter member 104 is then pressed into the opening 128 of the multi-piece wheel 102 and over the fitting member 114 and the radial sealing members 116 to seal the fitting member 114 against the adapter member 104, and to seal a cavity (similar or identical to the cavity 46 described above) from the atmosphere. When the adapter member 104 is subsequently pulled away from the opening 128 in an axial direction, the seal between the cavity and the atmosphere is broken and the tire begins to deflate. It will be appreciated that different adapter members 104 can be utilized for the different multi-piece wheels, including both new and existing multi-piece wheels.

According to various aspects, when a pressurized fluid (e.g., air) is introduced at the fill valve 120, the pressurized fluid is passed from the fill valve 120 to the internal passageway 126 of the adapter member 104, then to the internal passageway 118 of the fitting member 114. From the internal passageway 118 of the fitting member 114, the pressurized fluid is then passed to the cavity via an internal passageway 130 of the multi-piece wheel 102.

The safety member 106 is a ring-shaped member which covers the nuts and bolts which removably connect the first piece of the multi-piece wheel 102 to the second piece of the multi-piece wheel 102, and is removably connected to the adapter member 104 by the fasteners 112. Although only one fastener 112 is shown in the cross-section of FIG. 3, two fasteners 112 utilized to removably connect the safety member 106 to the adapter member 104 are shown in FIG. 5. According to various aspects, the fasteners 112 are cap screws (i.e., threaded all the way to the head of the fastener). According to various aspects, the safety member 106 is removably connected to the adapter member 104 before the adapter member 104 is pressed into the opening 128 of the multi-piece wheel 102. According to various aspects, the adapter member 104 can be formed integral to safety member 106.

The safety member 106 is removably connected to the multi-piece wheel 102 by the fasteners 110. The standoff members 108 are cylindrically shaped, have an opening (not shown) therethrough, and are utilized to keep the safety member 106 a fixed distance from the multi-piece wheel 102. According to various aspects, the standoff members 108 are formed integral with the safety member 106. According to various aspects, the safety member 106 defines openings 132 therethrough (See FIG. 5) and the fasteners 110 to pass through the openings 132 of the safety member 106, through the openings of the standoff members 108, and into threaded openings 134 (See FIG. 4 and FIG. 5) in the multi-piece wheel 102. The fasteners 110 are threadedly engaged with the multi-piece wheel 102.

To safely disassemble the multi-piece wheel 102 after the system 100 is fully installed, the fasteners 110 are removed from the multi-piece wheel 102. The safety member 106 can then be easily pulled away from the multi-piece wheel 102 in an axial direction, thereby giving access to the nuts and bolts which removably connect the first piece of the multi-piece wheel 102 to the second piece of the multi-piece wheel 102. The pulling away of the safety member 106 also operates to pull the adapter member 104 (which is connected to the safety member 106 by the fastener 112) away from the multi-piece wheel 102. The pulling away of the adapter member 104 from the multi-piece wheel 102 breaks the seal between the cavity and the atmosphere, and the tire begins to deflate. Once the tire is fully deflated, the nuts which connect the first piece of the multi-piece wheel 102 to the second piece of the multi-piece wheel 102 can be removed from the corresponding bolts, and the first piece of the multi-piece wheel 102 can then be safely removed from the second piece of the multi-piece wheel 102.

Although the safety member 106 is shown as a continuous ring in FIG. 5, it will be appreciated that the safety member 106 can be of other configurations. For example, according to various aspects, instead of a single safety member 106, the system 100 can include multiple safety members 106 (e.g., two, three, four, etc.) which collectively form a ring shape, and a number (e.g., two, four, etc.) of the multiple safety members 106 can be formed integral with at least one of the standoff members 108. Additionally, instead of a single ring having a uniform width which covers all of the nuts and bolts which help to connect the first piece of the multi-piece wheel 102 to the second piece of the multi-piece wheel 102, the safety member 106 can have scalloped or cutout portions which leave one or more of the nuts and bolts uncovered and therefore accessible when the safety member 106 is installed.

In certain situations, it is desirable to allow the multi-piece wheel 102 or a similar multi-piece wheel to be reverse mounted on a narrower wheel axle of a vehicle. In most cases, the narrower wheel axle is the rear axle of the vehicle. When the multi-piece wheel 102 is reverse mounted, the components of the system 100 are facing inboard and are relatively close to the hub and brake components of the vehicle.

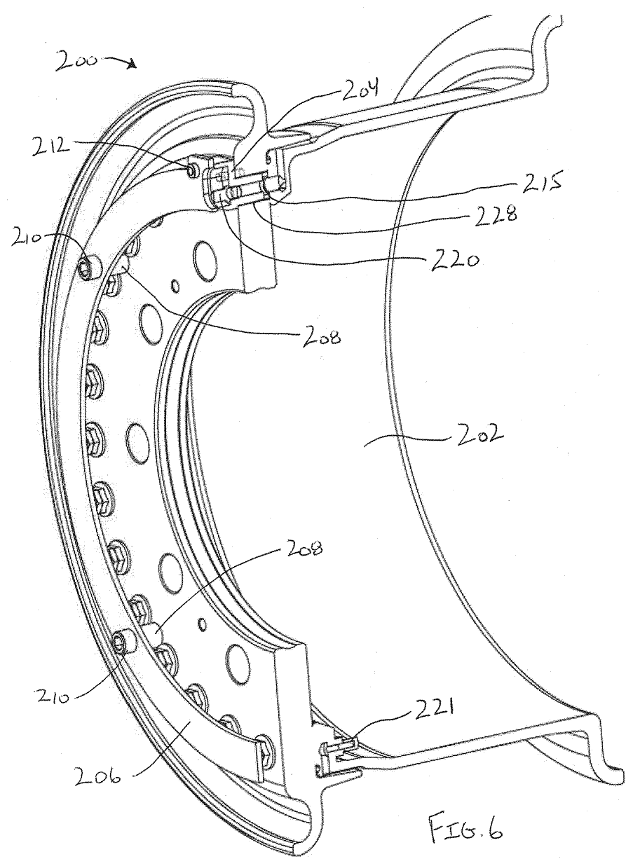

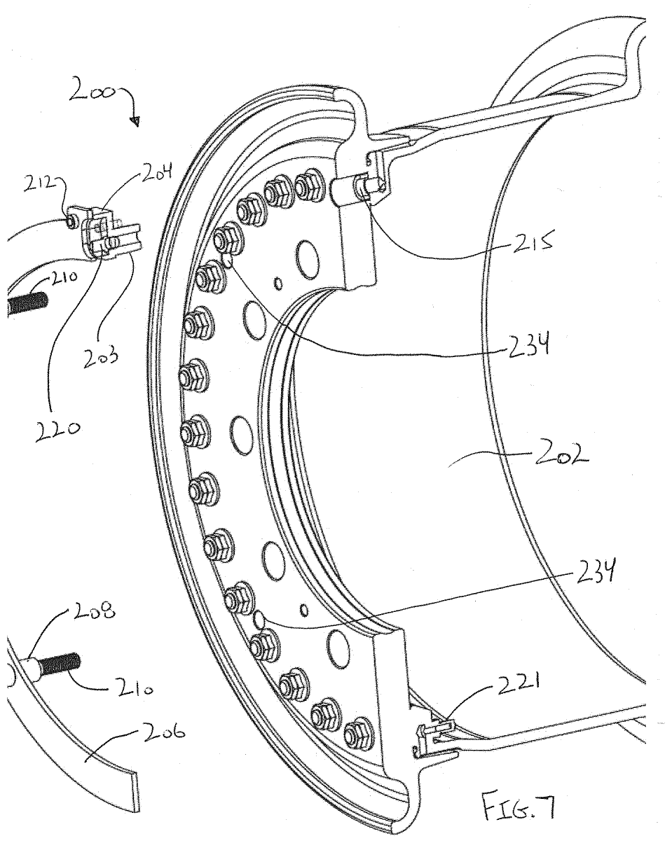

FIGS. 6-7 illustrate another deflation safety system 200, in accordance with at least one aspect of the present disclosure. The deflation safety system 200 can be utilized to safely disassemble a multi-piece wheel 202. FIG. 6 is a cross-section of the system 200, and FIG. 7 is an exploded view of the cross-section of the system 200. The multi-piece wheel 202 may be similar or identical to the multi-piece wheel 10 and/or the multi-piece wheel 102 described above, and may have a tubeless tire mounted thereon as described above. The system 200 can be utilized when the multi-piece wheel 202 is reverse mounted on a narrower wheel axle of a vehicle.

The system 200 includes an adapter member 204, a safety member 206, a plurality of standoffs 208, a plurality of corresponding fasteners 210 and fasteners 212. In accordance with various aspects, the system 200 forms part of another system which includes includes the multi-piece wheel 202, including the nuts, bolts, internal passageways, etc. of the multi-piece wheel 202, and may also include a tire mounted on the multi-piece wheel 202. The system 200 is similar to the system 100 in that the safety member 206, the standoffs 208, the fasteners 210 and the fasteners 212 are similar or identical to the safety member 106, the standoffs 108, the corresponding fasteners 110 and the fasteners 112 described above, and also in that the fill valve (not shown) of the multi-piece wheel 202 is removed prior to the installation of the system 200.

However, the system 200 is different from the system 100 in at least one way. In lieu of replacing the fill valve of the multi-piece wheel 102 with the fitting member 114 and the radial sealing members 116 as is done with the system 100, the fill valve of the multi-piece wheel 202 is replaced with a gasket 215. When the adapter member 204 is inserted into the opening 228 of the multi-piece wheel 202, the gasket 215 operates to seal the adapter member 204 and the multi-piece wheel 202, and thus operates to seal the cavity from the atmosphere. The use of the gasket 215 in lieu of the fitting member 114 and the radial sealing members 116 makes the system 200 more forgiving in terms of position tolerance between the adapter member 204 and the multi-piece wheel 202, easier to use and easier to service when needed.

As shown in FIG. 6, the fill valve 220 of the adapter member 204 faces perpendicular to the face of the transverse wall of the multi-piece wheel 202 (parallel to an axis of rotation of the multi-piece wheel 202). According to other aspects, the fill valve 220 of the adapter member 204 is oriented to face in a different direction (e.g., at an angle parallel to a face of the transverse wall of the multi-piece wheel 202). The elimination of the fitting member 114 and the radial sealing members 116, and the configuration of the adapter member 204 allows for the system 200 to have fewer components, have a smaller footprint and fit into smaller/tighter spaces, which is especially useful for cases where the multi-piece wheel 202 is reverse mounted. Additionally, as shown in FIGS. 6 and 7, the multi-piece wheel 202 can include a second fill valve 221 which is easily accessible from an “outboard” side when the multi-piece wheel 202 is reverse mounted.

To safely disassemble the multi-piece wheel 202 after the system 200 is fully installed, the fasteners 210 are removed from the multi-piece wheel 202. The safety member 206 can then be easily pulled away from the multi-piece wheel 202 in an axial direction, thereby giving access to the nuts and bolts which removably connect the first piece of the multi-piece wheel 202 to the second piece of the multi-piece wheel 202. The pulling away of the safety member 206 also operates to pull the adapter member 204 (which is connected to the safety member 206 by the fasteners 212) away from the multi-piece wheel 202. The pulling away of the adapter member 204 from the multi-piece wheel 202 breaks the seal between the cavity and the atmosphere, and the tire begins to deflate. Once the tire is fully deflated, the nuts which connect the first piece of the multi-piece wheel 202 to the second piece of the multi-piece wheel 202 can be removed from the corresponding bolts, and the first piece of the multi-piece wheel 202 can then be safely removed from the second piece of the multi-piece wheel 202.

Although the safety member 206 is shown as representative of a continuous ring in FIG. 6, it will be appreciated that the safety member 206 can be of other configurations. For example, according to various aspects, instead of a single safety member 206, the system 200 can include multiple safety members 206 (e.g., two, three, four, etc.) which collectively form a ring shape, and a number (e.g., two, four, etc.) of the multiple safety members 206 can be formed integral with at least one of the standoff members 108. Additionally, instead of a single ring having a uniform width which covers all of the nuts and bolts which help to connect the first piece of the multi-piece wheel 202 to the second piece of the multi-piece wheel 202, the safety member 206 can have scalloped or cutout portions which leave one or more of the nuts and bolts uncovered and therefore accessible when the safety member 206 is installed.

According to various aspects, the functionality of the adapter assembly 104 and/or the adapter assembly 204 can be integrated into a tire shield mounting member and utilized in a system which includes a tire shield and is configured for safely disassembling a multi-piece wheel.

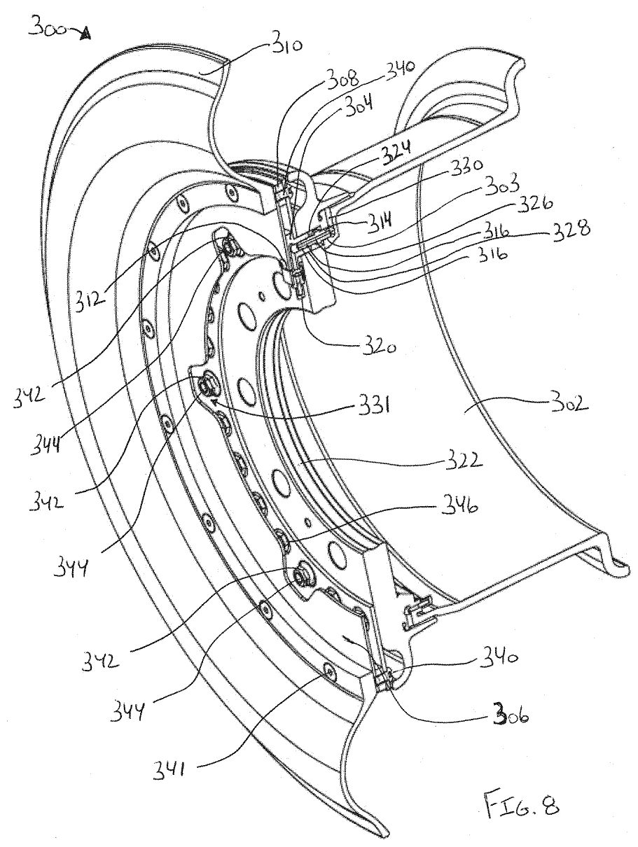

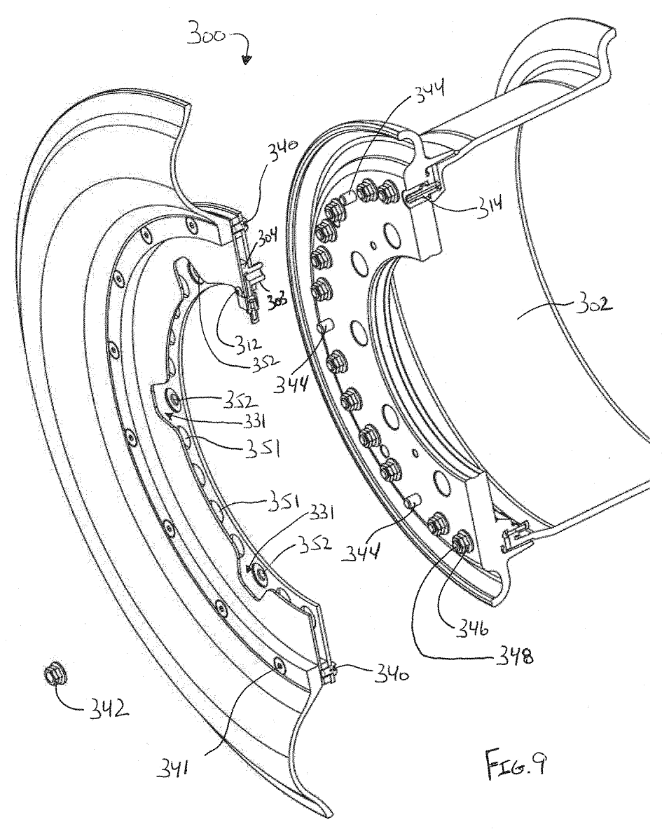

FIGS. 8-9 illustrate another deflation safety system 300, in accordance with at least one aspect of the present disclosure. The deflation safety system 300 can be utilized to protect a sidewall of a tire mounted to a multi-piece wheel 302 and/or safely disassemble the multi-piece wheel 302. FIG. 8 is a cross-section of the system 300, and FIG. 9 is an exploded view of the cross-section of the system 300. The multi-piece wheel 302 may be similar or identical to the multi-piece wheel 10, the multi-piece wheel 102 and/or the multi-piece wheel 202 described above, and may have a tubeless tire mounted thereon as described above.

The system 300 includes an adapter member 304, a safety member 306, a tire shield mounting member 308 and a tire shield 310. According to various aspects, the system 300 also includes a fitting member 314 and at least one radial sealing member 316. As shown in FIG. 8, the system 300 may include two radial sealing members 316. The fitting member 314 is similar or identical to the fitting member 114 and the radial sealing member 316 is similar or identical to the sealing member 116. In accordance with various aspects, the system 300 forms part of a system which includes the multi-piece wheel 302, including the nuts, bolts, internal passageways, etc. of the multi-piece wheel 302, and may also include a tire mounted on the multi-piece wheel 302.

Similar to the system 100, a fill valve (not shown) of the multi-piece wheel 302 is removed and replaced with the fitting member 314. According to various aspects, the fitting member 314 incorporates the radial sealing members 316. In accordance with various aspects, each of the radial sealing members 316 are O-rings. The fitting member 314 includes an internal passageway 318.

Also similar to the system 100, the adapter member 304 includes a fill valve 320 oriented in a manner similar to the fill valve 120 (e.g., facing at an angle parallel to the face of the transverse wall of the multi-piece wheel 302, facing perpendicular to the axis of rotation of the multi-piece wheel 302 toward a central opening 322 of the multi-piece wheel 302, etc.), an opening 324 configured to receive and surround the fitting member 314, and an internal passageway 326. The central opening 322 may be similar or identical to the central opening 36 and/or the central opening 122 described above. According to various aspects, the fitting member 314 is inserted into an opening 328 of the multi-piece wheel 302 and screwed into the threaded fill valve opening 303 of the multi-piece wheel 302. The adapter member 304 is then pressed into the opening 328 and over the fitting member 314 and the radial sealing members 316 to seal the fitting member 314 against the adapter member 304, and to seal a cavity (similar or identical to the cavity 46 described above) from the atmosphere. When the adapter member 304 is subsequently pulled away from the opening 328 in an axial direction, the seal between the cavity and the atmosphere is broken and the tire begins to deflate. It will be appreciated that different adapter members 304 can be utilized for the different multi-piece wheels, including both new and existing multi-piece wheels.

According to various aspects, when a pressurized fluid (e.g., air) is introduced at the fill valve 320, the pressurized fluid is passed from the fill valve 320 to the internal passageway 326 of the adapter member 304, then to the internal passageway 318 of the fitting member 314. From the internal passageway 318 of the fitting member 314, the pressurized fluid is then passed to the cavity via an internal passageway 330 of the multi-piece wheel 302.

The safety member 306 is a ring-shaped member which is similar to but different from the safety member 106, and is configured to cover a majority of, but not all of, the nuts and bolts which removably connect the first piece of the multi-piece wheel 302 to the second piece of the multi-piece wheel 302. For example, according to various aspects, the safety member 306 includes scallops and cut-outs 331 which leave six of the nuts and bolts not covered by the safety member 306 (only three of the “uncovered nuts and bolts are shown in the cross-section of FIG. 8). Also, although not shown in the cross-section of FIG. 8, the safety member 306 also includes a plurality of openings which are aligned with openings in the tire shield mounting member 308 and the tire shield 310. The system 300 includes fasteners 341 which pass through the openings of the safety member 306 and removably connect the tire shield 310 to the tire shield mounting member 308.

The safety member 306 is removably connected to the adapter member 304 by the fasteners 312 (only one of the fasteners 312 is shown in the cross-section of FIG. 8). According to various aspects, the fasteners 312 are cap screws (i.e., threaded all the way to the head of the fastener). According to various aspects, the safety member 306 is removably connected to the adapter member 304 before the adapter member 304 is pressed into the opening 328 of the multi-piece wheel 302 and over the fitting member 314. According to various aspects, the adapter member 304 can be formed integral to safety member 306. The safety member 306 is also removably connected to the tire shield mounting member 308 by the fasteners 340. As shown in FIG. 8, the safety member 306 is positioned between the tire shield mounting member 308 and the tire shield 310.

The tire shield mounting member 308 is connected to the multi-piece wheel 302 by the nuts and bolts which are not covered by the safety member 304. The “uncovered” nuts are shown as 342 and the “uncovered” bolts are shown as 344 in FIGS. 8 and 9. The “covered” nuts are shown as 346 in FIGS. 8 and 9 and the “covered” bolts 348, which are blocked from view by the safety member 304 in FIG. 8, are shown in FIG. 9. According to various aspects, the tire shield mounting member 308 includes a plurality of openings 351 (clearance holes) which are aligned with the “covered” nuts 346 and the “covered” bolts 348. The openings 351 are large enough to pass over/surround the “covered” nuts 346 and the corresponding “covered” bolts 348. The tire shield mounting member 308 also includes a plurality of openings 352 which align with the “uncovered” nuts 342 and the corresponding “uncovered” bolts 344. The openings 352 are smaller than the openings 351 such that the openings 352 can pass over/surround the “uncovered” bolts 344 but not the “uncovered” nuts 342. To install the tire shield mounting member 308 to the multi-piece wheel 302, the “uncovered” nuts 342 are removed from the “uncovered” bolts 344, the tire shield mounting member 308 is then positioned into place such that the openings pass over/surround the “covered” nuts 346, the corresponding “covered” bolts 348 and the “uncovered” bolts 344. The “uncovered” nuts 342 are then re-installed on the “uncovered” bolts 344 to secure the tire shield mounting member 308 to the multi-piece wheel 302. Thereafter, by removing the “uncovered” nuts 342 from the “uncovered” bolts 344, the tire shield mounting member 308 can be pulled away from the multi-piece wheel 302 in an axial direction. The pulling away of the tire shield mounting member 308 also operates to pull the adapter member 304, the safety member 306 and the tire shield 310 away from the multi-piece wheel 302. When the adapter member 304 is pulled away from the multi-piece wheel 302, the seal between the cavity and the atmosphere breaks and the tire begins to deflate.

The tire shield 310 is configured to protect the sidewall of a tire mounted to the multi-piece wheel 302 from damage caused by foreign objects. According to various aspects, the tire shield 310 covers a majority of a sidewall of the tire, has an outboard side which is convex and an inboard side which is concave. Tire shields such as tire shield 310 are described in more detail, for example, in U.S. Pat. No. 9,895,927, the entire content of which is hereby incorporated by reference. As set forth above, the tire shield 310 is removably connected to the tire shield mounting member 308 by a plurality of fasteners 341 which pass through openings in the safety member 306, and thus can be removed and replaced without having to remove the safety member 306, the adapter member 304 or the tire shield mounting member 308.

To safely disassemble the multi-piece wheel 302 after the system 300 is fully installed, the “uncovered” nuts 342 are removed from the “uncovered” bolts 344 which help to connect the first and second pieces of the multi-piece wheel 302 to one another. The tire shield mounting member 308 can then be easily pulled away from the multi-piece wheel 302 in an axial direction, thereby giving access to the rest of the nuts and bolts (i.e., the “covered” nuts 346 and the “covered” bolts 348) which removably connect the first piece of the multi-piece wheel 302 to the second piece of the multi-piece wheel 302. The pulling away of the tire shield mounting member 308 also operates to pull the adapter member 304, the safety member 306 and the tire shield 310 away from the multi-piece wheel 302. The pulling away of the adapter member 304 from the multi-piece wheel 302 breaks the seal between the cavity and the atmosphere, and the tire begins to deflate. Once the tire is fully deflated, the nuts previously covered by the safety ring 306 (i.e., the “covered” nuts 346) can be removed from the corresponding bolts 348, and the first piece of the multi-piece wheel 302 can then be safely removed from the second piece of the multi-piece wheel 302.

Although the safety member 306, the tire shield mounting member 308 and the tire shield 310 are each shown as representative of a continuous ring in FIG. 8, it will be appreciated that the safety member 306, the tire shield mounting member 308 and/or the tire shield 310 can be of other configurations. For example, according to various aspects, instead of a single safety member 306, the system 300 can include multiple safety members 306 (e.g., two, three, four, etc.) which collectively form a ring shape. Similarly, instead of a single tire shield mounting member 308, the system 300 can include multiple tire shield mounting members 308 (e.g., two, three, four, etc.) which collectively form a ring shape. Additionally, instead of a single ring having openings which pass over all of the “covered” nuts 346 and the covered bolts 348 which help to connect the first piece of the multi-piece wheel 102 to the second piece of the multi-piece wheel 102, the tire shield mounting member 308 can have scalloped or cutout portions such that at least one of the “covered” nuts 346 and the corresponding at least one of the covered bolts 348 is not surrounded by the tire shield mounting member 308.

### EXAMPLES

### Example 1

A system is provided. The system comprises an adapter member and a safety member. The adapter member comprises a fill valve, an internal passageway and a boss member positioned within a multi-piece wheel. The safety member is removably connected to the adapter member, and covers nuts which removably connect a first piece of the multi-piece wheel to a second piece of the multi-piece wheel.

### Example 2

The system of Example 1, wherein the fill valve faces (1) perpendicular to an axis of rotation of the multi-piece wheel, (2) parallel to a face of a transverse wall of the multi-piece wheel or (3) at an angle parallel to the face of the transverse wall of the multi-piece wheel.

### Example 3

The system of Examples 1 or 2, wherein the adapter member is further removably connected to a fitting member which is positioned within the multi-piece wheel.

### Example 4

The system of Example 3, wherein the fitting member comprises a sealing member and an internal passageway.

### Example 5

The system of Example 4, wherein the sealing member comprises at least one O-ring.

### Example 6

The system of Examples 4 or 5, wherein the internal passageway of the fitting member is in fluid communication with the internal passageway of the adapter member.

### Example 7

The system of Example 6, wherein the internal passageway of the fitting member is in further fluid communication with an internal passageway of the multi-piece wheel.

### Example 8

The system of Examples 1, 2, 3, 4, 5, 6 or 7, wherein the safety member is removably connected to the adapter member.

### Example 9

The system of Examples 1, 2, 3, 4, 5, 6, 7 or 8, wherein the safety member is further removably connected to the multi-piece wheel.

### Example 10

The system of Examples 1, 2, 3, 4, 5, 6, 7, 8 or 9, further comprising a standoff member positioned between the multi-piece wheel and the safety member.

### Example 11

The system of Example 10, further comprising a fastener which passes through the safety member, passes through the standoff member and is threadedly engaged with the multi-piece wheel.

### Example 12

The system of Examples 1, 2, 3, 4, 5, 6, 7, 8, 9, 10 or 11, further comprising at least one of the following: (1) a fitting member positioned within the multi-piece wheel and (2) the multi-piece wheel.

### Example 13

The system of Examples 1, 2, 3, 4, 5, 6, 7, 8, 9, 10, 11 or 12, further comprising gasket positioned in the multi-piece wheel, wherein the gasket is in contact with the boss member of the adapter member.

### Example 14

A system is provided. The system comprises an adapter member, a tire shield mounting member, a tire shield and a safety member. The adapter member comprises a fill valve, an internal passageway and a boss member positioned within a multi-piece wheel. The tire shield mounting member is removably connected to the multi-piece wheel. The tire shield is removably connected to the tire shield mounting member. The safety member is removably connected to the tire shield mounting member, and covers a majority of nuts which removably connect a first piece of the multi-piece wheel to a second piece of the multi-piece wheel.

### Example 15

The system of Example 14, wherein the adapter member is further removably connected to a fitting member which is positioned within the multi-piece wheel.

### Example 16

The system of Examples 14 or 15, wherein the fitting member comprises a sealing member and an internal passageway.

### Example 17

The system of Examples 14, 15 or 16, wherein the sealing member comprises an O-ring.

### Example 18

The system of Examples 14, 15, 16 or 17, wherein the internal passageway of the fitting member is in fluid communication with the internal passageway of the adapter member.

### Example 19

The system of Example 14, further comprising a gasket positioned within the multi-piece wheel and in contact with the adapter member.

### Example 20

The system of Examples 14, 15, 16, 17, 18 or 19, wherein the tire shield mounting member is removably connected to the multi-piece wheel by at least one of the nuts which removably connect the first piece of the multi-piece wheel to the second piece of the multi-piece wheel.

### Example 21

The system of Examples 14, 15, 16, 17, 18, 19 or 20, wherein the safety member is removably connected to the adapter member and the tire shield mounting member.

Although the various aspects of the system have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system, comprising:
an adapter member, wherein the adapter member comprises:
a fill valve;
an internal passageway; and
a boss member positioned within a multi-piece wheel; and
a safety member removably connected to the adapter member, wherein the safety member covers nuts which removably connect a first piece of the multi-piece wheel to a second piece of the multi-piece wheel.

2. The system of claim 1, wherein one of the following:
the fill valve faces perpendicular to an axis of rotation of the multi-piece wheel;
the fill valve faces parallel to a face of a transverse wall of the multi-piece wheel and
the fill valve faces at an angle parallel to the face of the transverse wall of the multi-piece wheel.

3. The system of claim 1, wherein the adapter member is further removably connected to a fitting member which is positioned within the multi-piece wheel.

4. The system of claim 3, wherein the fitting member comprises a sealing member and an internal passageway.

5. The system of claim 4, wherein the sealing member comprises at least one O-ring.

6. The system of claim 4, wherein the internal passageway of the fitting member is in fluid communication with the internal passageway of the adapter member.

7. The system of claim 6, wherein the internal passageway of the fitting member is in further fluid communication with an internal passageway of the multi-piece wheel.

8. The system of claim 1, wherein the safety member is removably connected to the adapter member.

9. The system of claim 1, wherein the safety member is further removably connected to the multi-piece wheel.

10. The system of claim 1, further comprising a standoff member positioned between the multi-piece wheel and the safety member.

11. The system of claim 10, further comprising a fastener which passes through the safety member, passes through the standoff member and is threadedly engaged with the multi-piece wheel.

12. The system of claim 1, further comprising at least one of the following:
a fitting member positioned within the multi-piece wheel; and
the multi-piece wheel.

13. The system of claim 1, further comprising gasket positioned in the multi-piece wheel, wherein the gasket is in contact with the boss member of the adapter member.

14. A system, comprising:
an adapter member, wherein the adapter member comprises:
a fill valve;
an internal passageway; and
a boss member positioned within a multi-piece wheel;
a tire shield mounting member removably connected to the multi-piece wheel;
a tire shield removably connected to the tire shield mounting member; and
a safety member removably connected to the tire shield mounting member, wherein the safety member covers a majority of nuts which removably connect a first piece of the multi-piece wheel to a second piece of the multi-piece wheel.

15. The system of claim 14, wherein the adapter member is further removably connected to a fitting member which is positioned within the multi-piece wheel.

16. The system of claim 15, wherein the fitting member comprises a sealing member and an internal passageway.

17. The system of claim 16, wherein the sealing member comprises an O-ring.

18. The system of claim 17, wherein the internal passageway of the fitting member is in fluid communication with the internal passageway of the adapter member.

19. The system of claim 14, further comprising a gasket positioned within the multi-piece wheel and in contact with the adapter member.

20. The system of claim 14, wherein the tire shield mounting member is removably connected to the multi-piece wheel by at least one of the nuts which removably connect the first piece of the multi-piece wheel to the second piece of the multi-piece wheel.

21. The system of claim 14, wherein the safety member is removably connected to the following:
the adapter member; and
the tire shield mounting member.
